(19) United States
(12) Patent Application Publication
(10) Pub. No.: US 2004/0012588 A1
(43) Pub. Date: Jan. 22, 2004

(54) Method for determining and displaying employee performance

(76) Inventor: Kelly Brookhouse Lulis, Lake Zurich, IL (US)

Correspondence Address: MOTOROLA, INC., 1303 EAST ALGONQUIN ROAD, IL01/3RD, SCHAUMBURG, IL, 60196

(21) Appl. No.: 10/195,921

(22) Filed: Jul. 16, 2002

(51) Int. Cl. G06T 11/20

(52) U.S. Cl. 345/440

(57) ABSTRACT

Each individual under a manager is given a first and a second performance score. The first performance score represents an employee's level of performance relative to goals established, while the second performance score is derived from a multi-rater assessment of leadership behavior. All individuals under a particular manager are then graphically displayed via an x-y graph with a first axis corresponding to the first performance score and a second axis corresponding to the second performance score.

### FIELD OF THE INVENTION

The present invention relates generally to displaying performance characteristics and in particular, to a method and system for graphically displaying employee performance.

### BACKGROUND OF THE INVENTION

Employee ranking is generally recognized as essential to the success of a business. Accurate employee ranking is essential, not only to place the right employee in the right job, but also to ensure fair compensation among employees. With this in mind, it has typically been the responsibility of managers to accurately, and fairly rank all employees reporting to them. Employee ranking is accomplished through a simple listing of employees from best to worst, making paired comparisons to establish rank, or by ranking employees on the basis of observations and other inputs, such as scores from a performance appraisal or other type of performance survey device.

Existing ranking methods, however, are largely ineffective because they usually require supervisors to mentally manipulate considerable information about employee performance to yield a ranking, frequently resulting in biased, inaccurate, or unfair rankings. Additionally, there exists no effective tool to graphically display a group of employees so that their relative performance can be compared. Therefore, there exists a need for a method and apparatus for determining and displaying employee performance that is more effective than prior-art methods.

### BRIEF DESCRIPTION OF THE DRAWINGS

FIG. 1 illustrates a graphical display of employee ranking in accordance with the preferred embodiment of the present invention.

FIG. 2 is a flow chart showing the steps necessary to generate the graphical display of FIG. 1 in accordance with the preferred embodiment of the present invention.

FIG. 3 illustrates a graphical display of employee ranking in accordance with the preferred embodiment of the present invention.

### DETAILED DESCRIPTION OF THE DRAWINGS

In order to address the above-mentioned need, a method for determining and displaying employee performance is described herein. In accordance with the preferred embodiment of the present invention each individual under a manager is given a first and a second performance score. The first performance score represents an employee's level of performance relative to established goals, while the second performance score is derived from a multi-rater assessment of leadership behavior. All individuals under a particular manager are then graphically displayed via an x-y graph with a first axis corresponding to the first performance score and a second axis corresponding to the second performance score.

Because each employee's ranking is based on multiple performance scores, a more accurate and objective picture of the employee's performance is achieved. Additionally, by displaying all employees on an xy-type graph, a manager can quickly determine employees' performance with respect to each other.

The present invention encompasses a method comprising the steps of determining a first performance score for an employee and determining a second performance score for the employee. Once determined, the first and the second performance score are graphically displayed as a data point in an x/y-type graph, wherein the first performance score represents an x-axis value, and the second performance score represents a y-axis value.

The present invention additionally encompasses an apparatus. The apparatus comprises an x/y-type graph having an x axis and a y axis, wherein the x axis represents a first performance score for an employee and the y axis represents a second performance score for the employee.

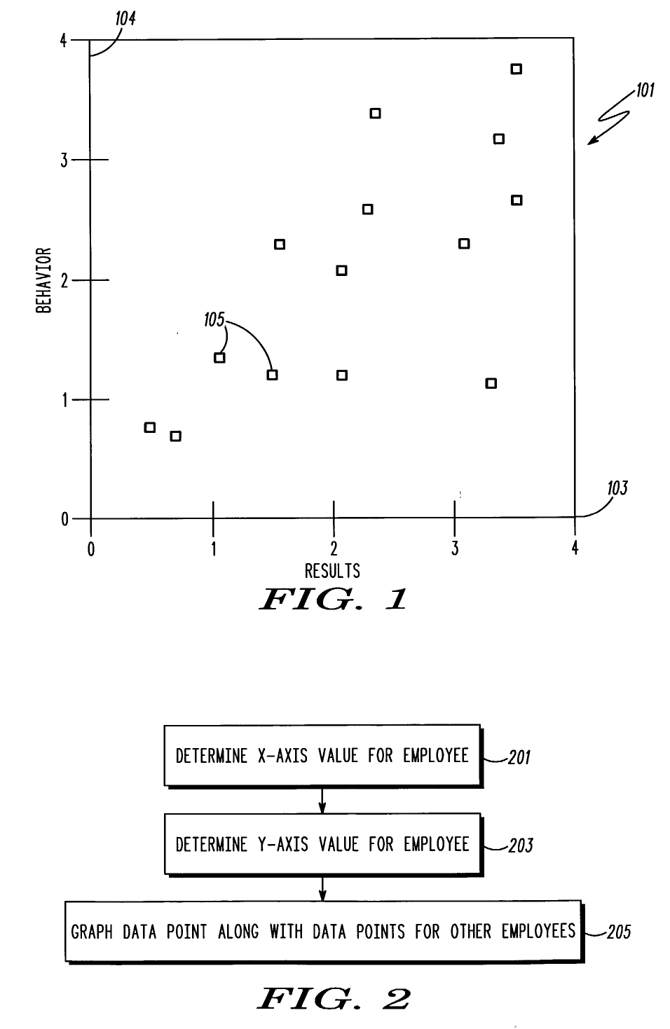

Turning now to the drawings, wherein like numerals designate like components, FIG. 1 illustrates a graphical display of employee ranking in accordance with the preferred embodiment of the present invention. As shown, graphical display 100 comprises an x/y type graph 101, x axis 103, and y axis 104. As shown, both x axis 103 and y axis 104 have a range between 0 and 4. Data points 105 reside on graph 101 and are representative of an individual employee's overall performance. In order to determine an individual employee's position on graph 101, an x-axis (Results) value and a y-axis value (Behavior) must be determined.

Determining an X-Axis Value (Results)

The Results score is the performance rating at the end of a period of time (e.g., end of the year) as representing the employee's level of performance relative to goals established at the start of the period. In the preferred embodiment of the present invention an employee and their manager will produce a set of individual goals for the employee at the beginning of the calendar year, and reach an agreement as to how successfully the goals were achieved by the end of the calendar year. The set of goals are preferably goals that should be accomplished during the calendar year.

After the calendar year, the employee and manager review the set of goals to determine if the goals have been met. In making this determination, the employee and manager may consider one, or all of the following:

Accomplishments during the last year compared to goals;

Demonstrated behaviors, compared to expectations discussed during previous performance dialogues, and the impact on achieving results;

Input received from key work partners;

Performance trends-both strengths and development needs;

Obstacles that may have interfered with job success, including prioritization, personal circumstances, resources, etc.;

Development or acquisition of specific skills and behaviors;

Current job match and development needs as well as anticipated changes in the business and their impact on job match and career plans.

In accordance with the preferred embodiment of the present invention, each employee achieves a Results score, initially between 0 and 4. The Results score is determined as follows:

Result score of 4—Substantially and Consistently Exceeded All Performance Expectations

Result score of 3—Steadily Met Performance Expectations and Exceeded Several

Result score of 2—Consistently Met Performance Expectations

Result score of 1—Did Not Consistently Meet Expectations—Some Improvement Needed

Result score of 0—Did Not Meet Sufficient Performance Expectations to Fulfill Job Responsibilities

Determining a Y-Axis Value (Behavior)

The Behavior score is derived from a multi-rater assessment of leadership behavior. The assessment comprises a set of questions targeting a company's standards for behavior. In the preferred embodiment of the present invention, the assessment consists of 40 questions targeted to the company's standards of leadership behavior. The assessment is preferably completed by the employee, the employee's manager, dotted-line managers (if any), and the employee's direct reports, however in alternate embodiments any individual that is familiar with the employee may complete the assessment. For each question on the assessment, assessors indicate the individual's level of effectiveness in demonstrating that behavior using the following scale:

0=Ineffective;

1=Adequate;

2=Effective;

3=Very Effective; and

4=Exceptionally Effective—Among the Best in the World.

An average score is obtained for each assessor, and a y-axis value is obtained based on the average score for each assessor. In the preferred embodiment of the present invention individual assessors may be weighted when computing a final Behavior score. For example, the employee's manager may receive added weight when computing a final y-axis value.

Displaying the End Result

Once an x-axis and y-axis value has been obtained for a manager's direct reports, the graph shown in FIG. 1 is produced. As discussed above, graphical display 100 comprises an x/y type graph 101, x axis 103, and y axis 104. In the preferred embodiment of the present invention the x axis and y axis values are determined as described above, however one of ordinary skill in the art will recognize that the x and y axis may be switched, with the x axis representing “behaviors” and the y axis representing “results”.

As is evident, the graph in FIG. 1 allows a manager to quickly determine a group of employees' rankings with respect to each other. Additionally, because an individual employee's ranking is based on both a “results” and “behavior” score, a more accurate picture of the employee's performance is achieved.

FIG. 2 is a flow chart showing the steps necessary to generate the graphical display of FIG. 1 in accordance with the preferred embodiment of the present invention. The logic flow begins at step 201 where an x-axis value is determined for an employee. As discussed above, the x-axis value is based on the employee achieving a number of goals that were set at an earlier date. At step 203 a y-axis value is determined. As discussed above, the y-axis value is based on an assessment of the employee as to how the employee's behaviors comply with a company's standards for behavior. Finally at step 205 a data point for the employee is graphed along with data points from other employees under a particular manager. In the preferred embodiment of the present invention the graph is displayed on a computer screen, however one of ordinary skill in the art will recognize that the above-described graph may be output on any media.

Because of the dynamic nature of the work environment, it is recognized that it is nearly impossible to capture every characteristic desirable in an employee's performance within the “Results” and “Behaviors” performance evaluation. For example, an employee who has recently taken a job may get average “results” scores, whereas a person who's been in the same job for 15 years may get a much higher score because their goals were easily met. The manager of these two people may believe that the first individual is actually the better performer because they took on a challenge and performed well, as opposed to the individual who is simply content with the status quo. Furthermore, the Results and Behaviors scores are based on ratings made by people. Raters use rating scales differently and are prone to rating errors such as halo, leniency, and central tendency.

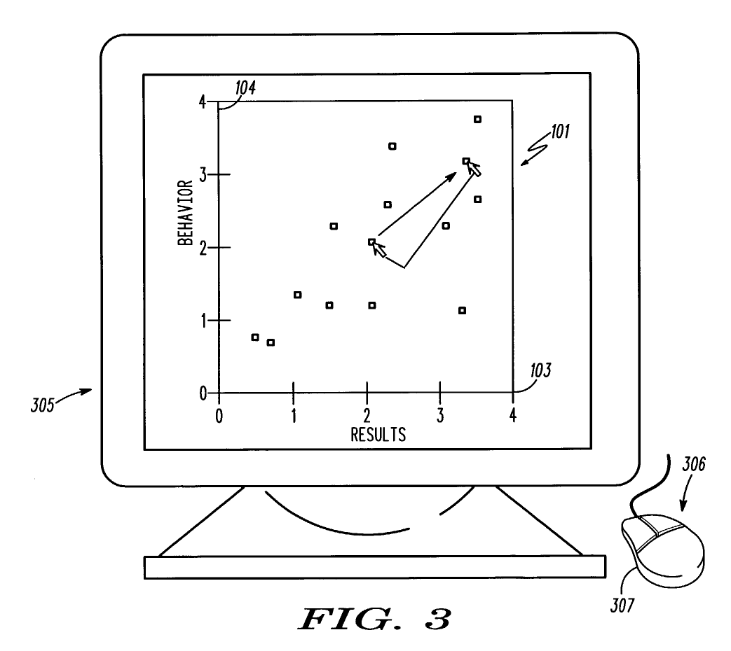

In order to address the dynamic nature of the work environment a “calibration” procedure is incorporated into the above-described rating system. In the preferred embodiment of the present invention the calibration process allows managers to “fine-tune” the individual's position relative to others by considering other legitimate performance factors like job complexity, goal difficulty, technical expertise requirements, time in position, etc. In accordance with the preferred embodiment of the present invention, a user is allowed to “grab” and “move” individual data points to better represent an employee's overall performance. This is illustrated in FIG. 3.

As shown in FIG. 3, the results and behaviors for individual employees are graphed and displayed on computer monitor 305 as described above. A user is allowed to adjust an employee's rating by “grabbing” the data point and moving it to a desired location. As shown in FIG. 3, an employee's data point is moved from location 301 to location 302. In the preferred embodiment of the present invention this is accomplished by passing cursor 303 over the data point and using mouse 306 to “grab” (by pressing and holding button 307) and “drag” the data point to the desired location.

While the invention has been particularly shown and described with reference to a particular embodiment, it will be understood by those skilled in the art that various changes in form and details may be made therein without departing from the spirit and scope of the invention. For example, although the above graph was described using an employees behaviors and results, one could use other metrics, such as an employees potential for performing a certain job. It is intended that such changes come within the scope of the following claims.

1. A method comprising the steps of:
determining a first performance score for an employee;
determining a second performance score for the employee; and
graphically displaying the first and the second performance score as a data point in an x/y-type graph, wherein the first performance score represents an x-axis value, and the second performance score represents a y-axis value.

2. The method of claim 1 wherein the step of determining the first performance score comprises the step of determining a performance score based on an ability to achieve a predetermined set of goals.

3. The method of claim 2 wherein the step of determining the second performance score comprises the step of determining a performance score based on an assessment of leadership behavior.

4. The method of claim 2 wherein the step of determining the second performance score comprises the step of determining a performance score based on a multi-rater assessment of leadership behavior.

5. The method of claim 1 wherein the step of graphically displaying comprises the step of graphically displaying on a computer monitor.

6. The method of claim 1 further comprising the steps of:
determining a first performance score for a second employee;
determining a second performance score for the second employee; and
graphically displaying the first and the second performance score for the second employee in the x/y-type graph.

7. The method of claim 1 further comprising the step of:
grabbing and moving the data point to better represent the employee's overall performance.

8. An apparatus comprising:
an x/y-type graph having an x axis and a y axis, wherein:
the x axis represents a first performance score for an employee; and
the y axis represents a second performance score for the employee.

9. The apparatus of claim 8 wherein the first performance score is based on an ability to achieve a predetermined set of goals.

10. The apparatus of claim 9 wherein the second performance score is based on an assessment of leadership behavior.

11. The apparatus of claim 9 wherein the second performance score is based on a multi-rater assessment of leadership behavior.

12. The apparatus of claim 8 wherein the apparatus comprises a computer monitor.
